(19) United States
(12) Patent Application Publication
(10) Pub. No.: US 2025/0059311 A1
(43) Pub. Date: Feb. 20, 2025

(54) Method for preparation of polysaccharide-based emulsion for binding and coating applications

(71) Applicant: Åbo Akademi, Åbo (FI)

(72) Inventors: Qiwen Yong, Åbo (FI); Chunlin Xu, Åbo (FI); Martti Toivakka, Åbo (FI)

(21) Appl. No.: 18/725,863

(22) PCT Filed: Dec. 29, 2022
(86) PCT No.: PCT/FI2022/050874

§ 371 Date: Jul. 1, 2024

(30) Foreign Application Priority Data
Dec. 31, 2021 (FI) 20216379

(51) Int. Cl. C08F 251/02; C08B 31/08; C08B 37/00; C09D 105/14

(52) U.S. Cl. CPC C08F 251/02; C08B 31/08; C08B 37/0057; C08B 37/0096; C09D 105/14

(57) ABSTRACT

According to an example aspect of the present invention, here is provided a polysaccharide ether grafted with poly(alkyl acrylate), a latex comprising a polysaccharide ether grafted with poly(alkyl acrylate), and a method of manufacturing a biobased emulsion comprising the steps of providing an allylated polysaccharide ether derivative and grafting the allylated polysaccharide ether derivative with a poly(alkyl acrylate) by emulsion polymerization, a biobased film formed by the said latex or said method and the use of the latex and emulsion.

### FIELD

The present invention relates to polysaccharide-based emulsions. In particular the present invention concerns novel polysaccharide-based emulsions and their uses for binding and coating applications.

### BACKGROUND

Latexes (elastomers) are soft amorphous polymers, which are commonly formulated as water-based dispersions (latexes) and used in numerous products, e.g., converted paper, packaging materials, coatings, textiles and car tyres. Currently, the commercial products are mainly oil-based, such as styrene-butadiene, styrene-acrylate and polyvinyl-acetate copolymers.

Currently, fossil fuel-based polymer materials for coating applications put a great threaten to environment and human's health. There is a pressing need for alternative bio-based polymer materials to replace the source of oil-based materials.

However, natural polymer coatings from wood like hemicelluloses are extremely hydrophilic and brittle due to presence of many hydroxyl groups and hydrogen bonds. Pristine hemicellulose cannot provide sufficient flexibility and adhesive property to be used as such in binding and barrier film applications. In order to prepare hemicellulose-based coatings, two main approaches have previously been used. The first method is physically blending the hemicellulose with plasticizers including glycerol, sorbitol xylitol, or emulsifiers like sucrose ester, palmitic acid, or polyvinyl alcohol. The physically-mixed hemicellulose-based films have lower brittleness and show better flexibility than pure hemicellulose-based films. However, the films are hydrophilic and sensitive to water/moisture. Another method for preparation of hemicellulose-based coatings is chemical modification of hemicellulose based on oxidation, reduction, etherification, esterification, amination, fluorination and crosslinking reaction. The resulting hemicellulose-based films can provide an improved hydrophobicity after modification, comparable to that of low density polyethylene films. However, the flexibility (strain at break, stress) of one-step chemically modified hemicellulose-based films is still low. In addition, such modified hemicelluloses mostly do not provide sufficient adhesion ability for being used as binders either.

### SUMMARY OF THE INVENTION

It is an aim of the present invention to reduce or even completely to eliminate the above-mentioned problems encountered in the art.

This invention provides a polysaccharide derivative, viz. a polysaccharide ether grafted with poly(alkyl acrylate). The derivative is in particular obtained by introducing, via ether bonds, groups containing unsaturated bonds onto the polysaccharide backbone, and by then reacting the derivative exhibiting unsaturated bonds with a reactant containing acrylate groups. By copolymerizing the modified polysaccharide with a specific poly(alkyl acrylate), for example via emulsion polymerization, a polysaccharide-based hybrid-emulsion can be provided which is suitable for various end-use application.

The polysaccharide-based emulsion finds uses in the paper, paperboard and packaging industry as well as broader coating and surface treatment products.

More specifically, the invention is defined by the features of the independent claims. Some specific embodiments are defined in the dependent claims.

According to a first aspect of the present invention, there is provided a polysaccharide ether grafted with poly(alkyl acrylate).

According to a second aspect of the present invention, there is provided a latex comprising a polysaccharide ether grafted with poly(alkyl acrylate).

According to a third aspect of the present invention, there is provided a method of manufacturing a biobased emulsion, comprising the steps of providing an allylated polysaccharide ether derivative; and grafting the allylated polysaccharide ether derivative with a poly(alkyl acrylate).

According to a fourth aspect of the present invention, there is provided a biobased emulsion formed by a method comprising the steps of providing an allylated polysaccharide ether derivative; and grafting the allylated polysaccharide ether derivative with a poly(alkyl acrylate) by emulsion polymerization.

According to a fifth aspect of the present invention there is provided a biobased film formed by a latex comprising a polysaccharide ether grafted with poly(alkyl acrylate) or a method comprising the steps of providing an allylated polysaccharide ether derivative; and grafting the allylated polysaccharide ether derivative with a poly(alkyl acrylate) by emulsion polymerization.

According to a sixth aspect of the present invention there is provided uses for latexes.

More specifically the present invention is characterized by what is stated in the independent claims.

Considerable advantages are obtained by the invention.

In one embodiment, a bi-functional monomer, such as allyl glycidyl ether containing epoxy groups and vinyl groups, is introduced and chemically bonded to a polysaccharide, such as hemicellulose, through etherification. Then the allylated polysaccharide is grafted with an alkyl acrylate monomer to prepare polysaccharide-based emulsions for coating applications for example using pre-emulsified semi-continuous emulsion polymerization.

The allylated polysaccharide ether derivative shows good binding properties, and films prepared from it have high flexibility with extensional strain up to 30% and hydrophobicity with water contact angle up to 117°, as well as optical transmittance of 92%. In the packaging industry, high transparency and low haze characteristics are usually desirable to enable the visibility of coated products. Thus, the allylated polysaccharide ether derivative provides an improved polysaccharide-based barrier coating composition. The present allylated polysaccharide ether derivative enhances the flexibility of conventional polysaccharide-based barrier coatings, wherein soft hemicellulose-based films can be obtained.

Partially bio-based replacement for polyolefin-based latex in numerous industrial and end user products. Examples include use as binder in, e.g., pigment coatings and paints; and barrier coating for paper and paperboard, notably in food-packaging and cosmetics. There is a clear need for new thermoplastic bio-based elastomers to replace the petroleum-derived synthetic polymers which are the main ones currently in use.

Further features and advantages of embodiments will become evident from the following description of preferred embodiments in which reference is made to the attached drawings.

### BRIEF DESCRIPTION OF THE DRAWINGS

FIG. 1 is a schematic depiction of the synthesis route of polysaccharide-based emulsions in accordance with at least some embodiments of the present invention;

FIG. 2 illustrates the hydrophobic properties of polysaccharide-based films with different substitution degrees based on water contact angle measurement in accordance with at least some embodiment of the present invention;

FIG. 3 illustrates the flexibility of the polysaccharide-based films with different substitution degrees in accordance with at least some embodiments of the present invention, and

FIGS. 4A and 4B illustrate the transparency and haze of polysaccharide-based films with different substitution degrees in accordance with at least some embodiments of the present invention.

### EMBODIMENTS

### Definitions

In the present context, the term “biobased” refers to a material that comprises, consists or essentially consists of a substance (or substances) derived from living matter (biomass) and either occur naturally or are synthesized.

As used herein, the term “average particle size” refers to the D₅₀ value of the cumulative volume distribution curve at which 50% by volume of the particles have a diameter less than that value.

As used herein, the term “about” refers to the actual given value, and also to an approximation to such given value that would reasonably be inferred to one of ordinary skill in the art, including approximations due to the experimental and/or measurement conditions for such given value.

Unless otherwise stated, properties that have been experimentally measured or determined herein have been measured or determined at room temperature.

Unless otherwise indicated, room temperature is 23° C.

Unless otherwise stated, properties that have been experimentally measured or determined herein have been measured or determined at atmospheric pressure.

In the present context, the expression “unsaturated groups” stands for groups which exhibit unsaturated bonds, such as double or triple bonds, either one or more per group—in case of several unsaturated bonds they may be conjugated or isolated—and which are capable of reacting with other groups, in particular with other groups of similar kind. In one embodiment, the groups have a double or triple bond.

According to an embodiment there is provided a polysaccharide ether grafted with poly(alkyl acrylate).

According to an embodiment the polysaccharide ether is obtained by grafting poly(alkyl acrylate) to allylic ether groups on the polysaccharide. Thus, according to a preferred embodiment, the obtained allylated polysaccharide ether derivative consist of water-soluble macromolecules containing double bonds.

According to an embodiment the poly(alkyl acrylate) is grafted to ether groups on the polysaccharide, which are obtained by reacting the polysaccharide with a bi-functional reactant containing epoxy groups and unsaturated groups, in particular vinyl or allyl groups.

In the present context, the term “degree of substitution”, abbreviated “DS”, refers to the average number of substituent groups attached per anhydromonose unit of the polysaccharide.

According to an embodiment the poly(alkyl acrylate) graft is obtained by polymerization, in particular by radical polymerization, of an alkyl acrylate monomer, in particular alkyl-acrylate monomer selected from the group of ethyl acrylate, n-propyl acrylate, isopropyl acrylate, and n-butyl acrylate, isobutyl acrylate, n-hexyl methacrylate, n-octyl methacrylate and isooctyl acrylate and n-butyl acrylate monomers and combinations thereof, in the presence of the polysaccharide ether. The monomer is selected from the group of monomers, which yield homopolymer that have low glass transition temperature, for example their glass transition temperature is between −80° C. and 20° C., such as −60° C. to 10° C. or as −50° C. to 0° C., and which monomers have hydrophobic long alkyl groups. “Long alkyl groups” refer to alkyl groups having 4 to 30 carbon atoms, in particular 8 to 24 carbon atoms.

In other words, a bi-functional monomer preferably containing reactive groups and unsaturated groups, is used for reacting with hydroxyl groups of polysaccharide to introduce double bonds onto polysaccharide molecular structure. Then the modified polysaccharide is copolymerized with a poly(alkyl acrylate), for example via emulsion polymerization, such as the pre-emulsified semi-continuous emulsion polymerization method, to synthesize the polysaccharide-based hybrid emulsion for the end-use application.

For the present purpose, the term “pre-emulsified semi-continuous emulsion polymerization” stands for a continuously operated emulsion polymerization process, in which the monomers to be fed into the polymerization are pre-emulsified separately before they are feed in the polymerization reaction.

In one embodiment there is provided a method for synthesis of a galactoglucomannan (in the following “GGM”)-based emulsion for binding and coating applications. The first step is the introduction of a bi-functional monomer containing epoxy groups and vinyl groups by etherification reaction between epoxy groups and hydroxyl groups of GGM. The allylated GGM exhibiting a substitution degree of double bonds is further copolymerized with an acrylic monomer. In particular copolymerization is carried out by a pre-emulsified semi-continuous emulsion polymerization method to prepare the GGM-based emulsions.

After being cast and dried at room temperature, the resultant GGM-based films show flexibility with extensional strain up to 30% and hydrophobic properties with water contact angle of up to 117°, as well as optical property with transmittance of 90% or more, e.g. 92%. In addition, the use of the GGM-based emulsion as a binder was tested by gluing two pieces of wood with 1.5×1.5 cm² surface area together. The tensile bond strength was found to be high, i.e. the hemicellulose-derivative appears to function as a glue. The invention can be extended to other hemicelluloses or polysaccharides that are structurally similar, e.g. xylans from wood and lower plants and glucomannans from different sources.

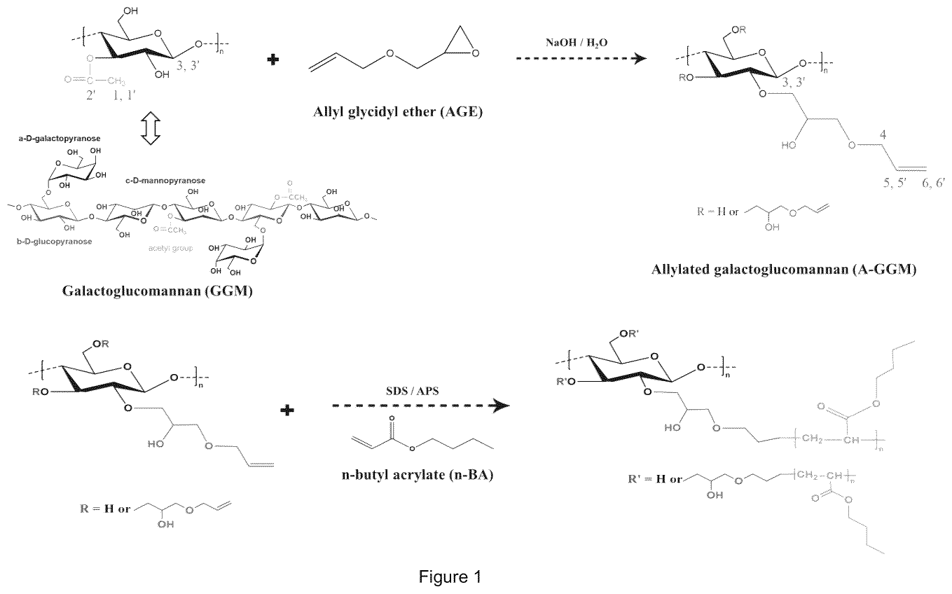

FIG. 1 illustrates the synthesis route of a polysaccharide derivative latex in accordance with at least some embodiments of the present invention employing galactoglucomannan as polysaccharide, allyl glycidyl ether and n-butyl acrylate as exemplifying reactants.

For the sake of order it should be pointed out that in place of reactants and other components shown in FIG. 1 other substances can be used, as will be separately explained. At least a part of, in particular the whole, synthesis process is carried out in water-phase.

According to the synthesis route in FIG. 1 first, a GGM polymer is provided. The polymer comprises 2 to 1000 monomers, typically about 5 to 100. C═C double bonds are introduced onto GGM backbone, in particular by grafting, to prepare an allylated GGM with suitable substitution degree to enable subsequent free radical copolymerization. This is achieved through etherification reaction between hydroxyl groups of GGM and epoxy groups of allyl glycidyl ether (AGE) performed in aqueous sodium hydroxide solution in an inert atmosphere for about 10 hours at a temperature of about 60° C.

In the second step of the synthesis route, the unsaturated C═C double bonds of AGE grafted on the hemicellulose backbone are used as reaction sites of the free-radical copolymerization of n-butyl acrylate (n-BA) in semi-continuous emulsion polymerization process. The polymerization process is performed in an inert atmosphere for about 4 hours as a temperature of about 80° C. in the presence of ammonium persulfate initiator and sodium dodecyl sulfate surfactant. The final product of the polymerization process is a GGM-based emulsion.

The poly(alkyl acrylate), particularly n-butyl acrylate, can be obtained from fully biomass resources based on the bio-based alcohol fermented from glucose and the bio-based acrylic acid converted from lactic acid. By using biomass resources, the biomass content accounted for in the ready product is up to 95%.

According to an embodiment the polysaccharide has a degree of substitution of up to 1.5, in particular up to 1.0, for example of about 0.04 to 0.83, 0.10 to 0.51, or 0.30 to 0.83. The degree of substitution is measured by high pressure size exclusion chromatography with dimethyl sulphoxide/lithium bromide as solvent and eluent.

According to an embodiment the polysaccharide is selected from the group of starch, guar gum and hemicellulose and combinations thereof.

In one embodiment, the polysaccharide is derived from wood.

According to one embodiment the polysaccharide is hemicellulose, especially wood-derived hemicellulose.

According to an embodiment the hemicellulose comprises galactoglucomannan, xylan, arabinogalactan, arabino-gluronoxylan, xyloglucan, beta-glucan, alpha-glucan or combinations thereof.

According to an embodiment there is provided a latex comprising a polysaccharide ether grafted with poly(alkyl acrylate) as described above.

According to an embodiment the latex has a Z-average particle size of about 50 to 250 nm, for example about 100±20 nm, determined by Zeta-sizer Nano ZS90 type laser nanometer particle size analyzer (Malvern, UK) with a 633 nm red laser.

The resultant polysaccharide-based emulsions comprise or consist of at least up to 20%, preferably at least up to 40%, in particular up to 50% or more of bio-based raw material and show good binding to other materials, water-resistance, as well as high film flexibility and transparency. According to an embodiment the latex has a content of biobased materials of up to 95% by weight, preferably 70-95% by weight, in particular 75-95% by weight, for example 90-92% by weight, calculated from the solid matter of the latex, provided that the poly(alkyl acrylate) is obtained from biobased raw-materials.

According to an embodiment the latex has a solids content of 10 to 50% by weight measured from the weight of the whole latex material.

According to an embodiment there is provided a method of manufacturing a biobased emulsion, comprising the steps of providing an allylated polysaccharide ether derivative; and grafting the allylated polysaccharide ether derivative with a poly(alkyl acrylate) by emulsion polymerization. According to a preferred embodiment, the method provides one-step emulsion polymerization reaction between the allylated polysaccharide and alkyl-acrylate monomer, the reaction suitably being inhomogeneous reaction between water-soluble allylated polysaccharide and water-insoluble alkyl-acrylate monomer.

According to an embodiment the allylated polysaccharide ether derivative is obtained by reacting polysaccharide with a bi-functional reactant containing epoxy groups and vinyl groups to chemically bond to polysaccharide by etherification.

According to an embodiment the bi-functional monomer contains epoxy groups and vinyl groups is allyl glycidyl ether.

According to an embodiment the method further comprises providing a polysaccharide ether derivative exhibiting ether substituents with allyl groups at a degree of substitution of up to 1.5, in particular up to 1.0, for example of about 0.04 to 0.83, 0.10 to 0.51, or 0.30 to 0.83. The degree of substitution is measured by high pressure size exclusion chromatography with dimethyl sulphoxide/lithium bromide as solvent and eluent.

According to an embodiment the alkyl-acrylate monomer is selected from the group of ethyl acrylate, n-propyl acrylate and n-butyl acrylate monomers and combinations thereof.

According to an embodiment the polysaccharide has a number average molecular weight of 2,000-50,000 g/mol, preferably 5,000-20,000 g/mol, in particular 6,500-10,000 g/mol and a weight average molecular weight of 2,000-100,000 g/mol, preferably 5,000-20,000 g/mol, in particular 10,000-35,000 g/mol as measured by a high-performance size exclusion chromatography.

According to an embodiment the allylated polysaccharide has a number average molecular weight of 2,000-50,000 g/mol, preferably 5,000-20,000 g/mol, in particularly 6,500-10,000 g/mol, and a weight average molecular weight of 2,000-100,000 g/mol, preferably 5,000-50,000 g/mol, in particular 10,000-35,000 g/mol, as measured by a high-performance size exclusion chromatography.

According to an embodiment the polysaccharide is selected from the group of starch, guar gum and hemicellulose.

According to an embodiment the hemicellulose is selected from the group of galactoglucomannan, xylan, arabinogalactan, arabino-gluronoxylan, xyloglucan beta-glucan, alpha-glucan or combinations thereof.

According to an embodiment the emulsion polymerization is carried out by semi-continuous emulsion polymerization, in particular by pre-emulsified semi-continuous emulsion polymerization.

According to one embodiment the etherification of polysaccharide is carried out at alkaline conditions, preferably at pH of 8 to 12, more preferably at pH of 10 to 12, especially in an aqueous alkaline solution, such as aqueous NaOH solution.

According to an embodiment the etherification of polysaccharide is carried out in an inert atmosphere at alkaline conditions and in particular at a temperature of 30 to 90° C., for example 40 to 75° C.

According to an embodiment the method further comprises the steps of: adding sodium hydroxide into the polysaccharide, adding, after dissolving of sodium hydroxide, a bi-functional monomer, such as allyl glycidyl ether, at a molar ratio of 1:1 to 1:5 based on anhydromonose units, continuing the reaction until completion, for example for 0.5 to 24 hours, in particular for 5 to 12 hours in an inert atmosphere, and optionally neutralizing the reaction mixture for example using a mineral acid, such as hydrochloric acid or sulphuric acid.

According to an embodiment the method further comprises filtering the allylated polysaccharide derivative with a membrane, for example having an exclusion size of at least 500 Da, such as 12˜14 kDa, to remove unreacted monomer, said filtering being carried out for a period of 1 to 180 h, for example 6 to 106 h or 12 to 78 h, such as about 72 h, typically at room temperature.

According to an embodiment the method comprises carrying out the grafting reaction in the presence of a surfactant, such as sodium dodecyl sulphate or sodium dodecyl sulphonate, for example added in an amount of 0.1 to 2.5 wt-%, in particular about 1 wt-%, based on total weight of the alkyl-acrylate monomer, and by optionally further adding a radical initiator, such as ammonium persulphate, potassium persulphate or sodium persulphate, in particular 0.1 to 2.5 wt %, such as 0.5 to 2 wt %, for example 1-wt %, of the ammonium, potassium persulphate or sodium persulfate, based on total weight of alkyl-acrylate monomer, and carrying out the reaction in inert atmosphere, for example under nitrogen atmosphere, at a temperature in excess of 50° C., such as of about 80° C. for 1 to 10 hours, for example for about 4 hours.

Thus, according to one embodiment, the grafting reaction is performed at a temperature in excess of 50° C., preferably in the range of 50 to 100° C., such as of about 80° C.

According to one embodiment, the optional external surfactant, such as sodium dodecyl sulphate or sodium dodecyl sulphonate, forms micelles that act as an additional reaction point providing connections between hydrophilic allylated polysaccharide and hydrophobic alkyl acrylate monomer for polymerization.

According to one embodiment, stirring rate during the grafting reaction is 500 to 2000 r/min, such as 1000 to 1500 r/min. In one embodiment, the stirring rate during adding and dissolving the optional surfactant is 500 to 2000 r/min. In one embodiment, the stirring rate is 1000 to 1500 r/min prior to adding the optional surfactant.

According to an embodiment the method further comprises casting and drying the formed emulsion into a film at 23° C. and 50% humidity lasting for 48 h.

According to an embodiment there is provided a biobased emulsion formed by the method described above comprising the steps of providing an allylated polysaccharide ether derivative; and grafting the allylated polysaccharide ether derivative with a poly(alkyl acrylate) by emulsion polymerization.

According to an embodiment there is provided a biobased film formed by the latex as described above comprising a polysaccharide ether grafted with poly(alkyl acrylate) or by the method described above comprising the steps of providing an allylated polysaccharide ether derivative; and grafting the allylated polysaccharide ether derivative with a poly(alkyl acrylate) by emulsion polymerization.

The hydrophobicity of the film is evaluated by the contact angle of a water droplet on its surface. According to an embodiment the film has a hydrophobicity with water contact angle of 95-130°, preferably 105-120°, in particular 115-120°. The hydrophobicity is tested based on water contact angle at 25° C. under 4 μL per drop condition.

The transparency and haze are tested on an ultra-visible spectrometer at the range of 300-800 nm. According to an embodiment the film has a transmittance of 85-95%, preferably 90-92% measured at a wavelength of 550 nm. The transmittance is measured by a Shimadzu UV-2600 spectrometer equipped with integrating sphere attachments according to the ASTM D1003 standard test method. The determined wavelength range is between 323 and 800 nm and the corresponding values at 550 nm is selected for comparison.

According to an embodiment the film has a haze of less than 6%, preferably less than 5%, in particular less than 4%. The haze is measured by a Shimadzu UV-2600 spectrometer equipped with integrating sphere attachments according to the ASTM D1003 standard test method. The determined wavelength range is between 323 and 800 nm and the corresponding values at 550 nm is selected for comparison.

According to an embodiment the thickness of the film is 20-100 μm, preferably 40-80 μm, in particular 50-70 μm.

According to an embodiment the water vapor permeability of the film is 0.10-0.50 g mm/(m² d kPa), preferably 0.12-0.40 g mm/(m² d kPa), in particular 0.14-0.2 g mm/(m² d kPa). The water vapour permeability rates are characterized according to the ASTM standard E96/E96M-10.

The flexibility of the film can be determined by measuring the tensile stress and tensile strain. The flexibility is tested by cutting films into rectangle shape with 6 cm×4 mm and the films are mounted with a distance of 2 cm between the clamps. The films are stretched at a speed of 10 mm/min under room temperature. The film thickness is controlled around at 60 μm. Both the tensile stress and tensile strain are affected by the substitution degree during the polymerization reaction. The grafted polymer molecular chains were very long and flexible after the introduction of alkyl acrylate monomer in second step of graft polymerization, which was determined by the nature of the molecular structure of alkyl acrylate monomer, leading to the increase of the elongation at break without sacrificing the tensile stress. According to an embodiment, the film has a tensile strain at break of 15-40%, preferably 20-35%, in particular 25-30%.

According to an embodiment the film has a maximum tensile stress of 20-40 MPa, preferably 25-35 MPa, in particular 28-32 MPa.

According to an embodiment, the film has good thermal stability. The film has two distinct stages of decomposition. The first decomposition stage is at around 300° C., which attributes to the degradation of the polysaccharide macromolecular chains. The second decomposition stage is at about 420° C., which corresponds to the decomposition of the alkyl acrylate grafted macromolecular chains.

According to an embodiment there is provided a biobased binder formed by the latex as described above comprising a polysaccharide ether grafted with poly(alkyl acrylate) or by the method described above comprising the steps of providing an allylated polysaccharide ether derivative; and grafting the allylated polysaccharide ether derivative with a poly(alkyl acrylate) by emulsion polymerization.

According to an embodiment the binder has a tensile bond stress at break of 1-5 MPa, preferably 1.2-4.5 MPa, in particular 1.5-4 MPa when measured in a tensile test with two pieces of wood having 1.5×1.5 cm² surface area.

According to an embodiment the latex provided as described above is used for coating applications, such as coatings for paper, paperboard, preferably in food-packaging and for cosmetics packaging.

According to an embodiment the latex provided as described above is used as a binder, such as binder in pigment coatings or paints, or as an adhesive, such as an adhesive for gluing wood and wood products, or composites.

The following non-limiting example illustrates an embodiment.

### EXAMPLE

Firstly, 10 g of hemicellulose-native GGM was dissolved in 100 mL deionized water for stirring overnight at room temperature. The reaction system was equipped with a condenser, a magnetic stirring apparatus with oil bath and a continuous flow of nitrogen and 2% of sodium hydroxide was added into GGM solution, after dissolving of sodium hydroxide different molar ratio of bi-functional monomer allyl glycidyl ether based on anhydromannose units was added for reaction at 60° C. lasting for 10 h under nitrogen atmosphere. Cooling to room temperature, the above dispersion was 100% neutralized with diluted hydrochloric acid and monitored with pH electronic device.

The allylated GGM dispersion with different substitution degree tested with quantitative 13CNMR spectra ranging from 0.30 to 0.83 was prepared successfully.

The allylated GGM dispersion was used for dialysis with dialysis membrane of 12˜14 KDa cut to remove unreacted monomer for 72 h when GGM has a molar mass larger than 12˜14 KDa. A smaller cut-off dialysis membrane was used when starting GGM has a molar mass lower than 12˜14 kDa.

The above allylated GGM dispersion was transferred into a three necked round-bottom flask and heated to 80° C. 1% of sodium dodecyl sulfate based on total weight of n-butyl acrylate was added to the flask for dissolving 15 min, 30% of 10 g of n-butyl acrylate is added for pre-emulsification under vigorous stirring for 15 min. After that, the remaining 70% of n-butyl acrylate and 1% of ammonium persulfate based on total weight of n-butyl acrylate was dropwise added by peristaltic pump within 3 h. The reactive system was incubated for another 1 h to prepare the GGM-based emulsions.

The GGM-based emulsions were casted on a petri dish for drying at 23° C. and 50% humidity lasting for 48 h to obtain the GGM-based films for barrier applications.

The hydrophobic property was tested on the GGM-based films with different substitution degrees based on water contact angle at 25° C. under 4 μL per drop condition.

The flexibility was tested on the GGM-based films with different substitution degrees, which are cut into rectangle shape with 6 cm×4 mm, and the films are mounted with a distance of 2 cm between the clamps. The films were stretched at a speed of 10 mm/min under room temperature. The film thickness was controlled to about 60 μm.

The film transparency and haze of the GGM-based films with different substitution degrees were tested on an Ultra-visible spectrometer at the range of 300-800 nm.

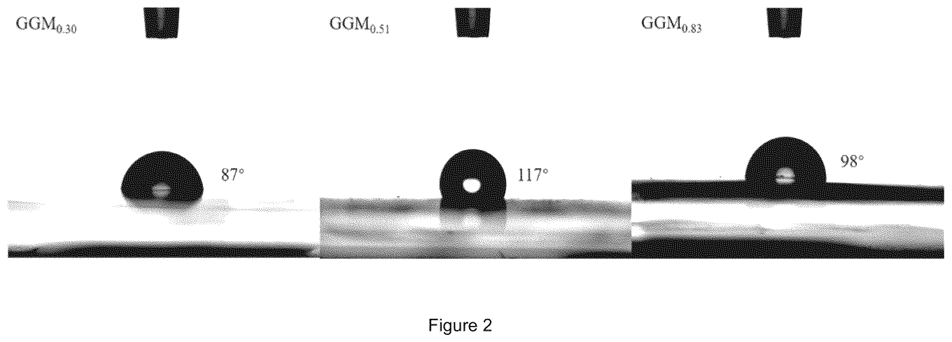

The results of the above tests are shown in FIGS. 2 to 4.

In addition, the tensile bond strength of the latexes was measured through a tensile test. The GGM-based emulsion was coated on the cross section of two pieces of wood with 1.5×1.5 cm² surface area. The glued two pieces of wood were put in room temperature for 10 h before the tensile test. The tensile test was performed for GGM-based latexes having substitution degrees of 0.30, 0.51 and 0.83. The tensile bond stress at break for the different latexes were 1.60 MPa, 2.32 MPa and 3.78 MPa respectively.

FIG. 2 illustrates the hydrophobic properties of polysaccharide-based films with different substitution degrees based on water contact angle measurement in accordance with at least some embodiment of the present invention.

The hydrophobicity of the film is evaluated by the contact angle of a water droplet on its surface. The hydrophobic properties of GGM with a substitution degree of 0.30, 0.51 and 0.83 is presented in FIG. 2. The GGM with a substitution degree of 0.30 has a contact angle of 87°, the GGM with a substitution degree of 0.51 has a contact angle of 117° and the GGM with a substitution degree of 0.83 has a contact angle of 98°.

In the case of GGM, the decrease of water contact angles may attribute to surface roughness of the GGM film, as contact angles can be affected by two main factors: polarity and surface roughness. With an increase in the AGE content, more and more hydroxyl groups attached onto the hemicellulose backbone are substituted by allylated groups of AGE, which means that a large number of C═C double bonds are grafted on GGM molecular chains. For example, GGM product that declares a DS of 0.83, the heteropolymer of allylated GGM with a greater high DS is copolymerized with n-BA monomer to form cross-linking and interpenetrating network between the molecular chains, leading to the gel fabrication of GGM product, which in turn shows a greater surface roughness on its film surface.

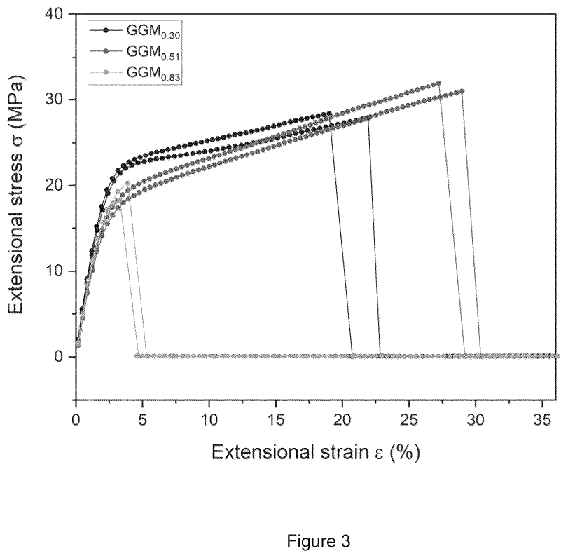

FIG. 3 illustrates the flexibility of GGM-based films with different substitution degrees based on tensile test. Tensile tests showing the extensional (tensile) stress versus extensional (tensile) strain are presented for films with substitution degrees of 0.30, 0.51 and 0.83.

Generally, the GGM film specimen with an allylated substitution degree of about 0.51, yields a film with the optimal mechanical property, i.e., 31.2% of ε and 30.9 MPa of σ. This is due to that the grafted polymer molecular chains were very long and flexible after the introduction of n-BA monomer in second step of graft polymerization, which was determined by the nature of the molecular structure of n-BA monomer, leading to the increase of the elongation at break without sacrificing the tensile stress.

The GGM film with higher allylated substitution degree has branched chains of the hemicellulose that are crosslinked and tangled with each other during the second polymerization stage. Therefore, a large amount of cross-linked network structure limited the movements between and inside macromolecular chains, leading to less flexibility of the GGM film.

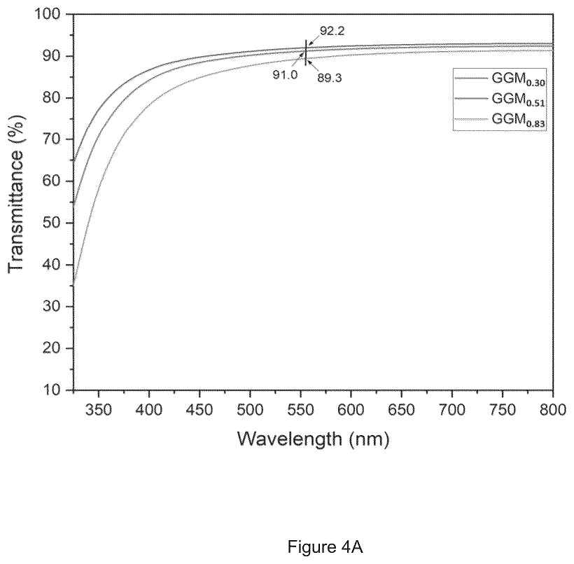

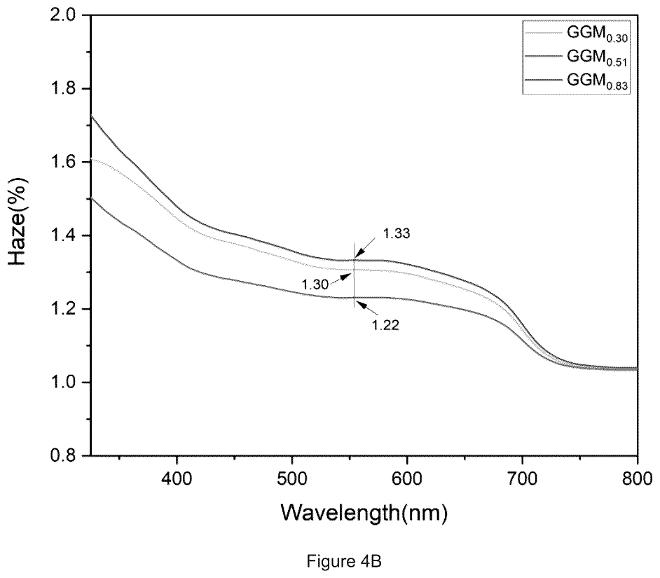

FIGS. 4A and 4B illustrate the film transparency and haze of the polysaccharide-based films with different substitution degrees in accordance with at least some embodiment of the present invention.

It can be seen from FIG. 4A that all the films have a high transparency, especially in the wavelength of 550 nm. The C═C conversion rate has a slight effect on the transparency of the film. Also, all the films show a steep drop in the ultraviolet light range, that is below 400 nm, indicating a block of ultraviolet light transmittance. This result is of great benefit for the preservation of product in packaging coatings as the most pronounced detrimental effects of light are usually induced by ultraviolet light.

Haze is used to quantify the percentage of the forward light scattering. It can be seen from FIG. 4B that all the films have low transmission haze. The higher substitution degree of allylated groups leads to a high polymerization density that reduces the light scattering and thus decreases the haze.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention. Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The latexes and emulsion according to the current invention can be used as glues, adhesives and binders. Particularly, they can be used as glues and adhesives in wood-based products such as plywood or as binders in applications such as pigment coatings and paints. The films according to the current invention can be used as films in packaging materials, such as to replace aluminum foil, PE, PP, PVDC or EVOH, for food, cosmetics and pharmaceuticals or as barrier coatings for paper and paperboard. Also, the latexes according to the current invention can be used in swim caps, chewing gum, mattresses, catheters, rubber bands, balloons, tennis shoes, and many other sporting goods. In other applications, latex can also be added to cement used for resurfacing and patching cracks in cement surfaces.

### ACRONYMS LIST

AGE Allyl glycidyl ether
DS Degree of substitution
GGM Galactoclucomannan
EVOH Ethylene vinyl alcohol
PE Polyethylene
PP Polypropylene
PVDC Polyvinylidene chloride

1. A polysaccharide ether grafted with poly(alkyl acrylate), wherein the poly(alkyl acrylate) is grafted to ether groups obtained by reacting a polysaccharide with a bi-functional reactant comprising epoxy groups and unsaturated groups.

2. The polysaccharide ether according to claim 1, obtained by grafting poly(alkyl acrylate) to allylic ether groups on the polysaccharide.

3. The polysaccharide ether according to claim 1, wherein the poly(alkyl acrylate) is grafted to ether groups obtained by reacting the polysaccharide with a bi-functional reactant comprising vinyl or allyl groups.

4. The polysaccharide ether according claim 1, wherein the poly(alkyl acrylate) graft is obtained by polymerization of an alkyl-acrylate monomer selected from the group consisting of ethyl acrylate, n-propyl acrylate, isopropyl acrylate, n-butyl acrylate, isobutyl acrylate, n-hexyl methacrylate, n-octyl methacrylate, and isooctyl acrylate monomers and combinations thereof, in the presence of the polysaccharide ether.

5. The polysaccharide ether according to claim 1, the polysaccharide ether having a degree of substitution of up to 1.5.

6. The polysaccharide ether according to claim 1, wherein the polysaccharide is selected from the group consisting of starch, guar gum, and hemicellulose.

7. The polysaccharide ether according to claim 6, wherein the hemicellulose comprises galactoglucomannan, xylan, arabinogalactan, arabino-gluronoxylan, xyloglucan, beta-glucan, alpha-glucan, or combinations thereof.

8. A latex comprising the polysaccharide ether grafted with poly(alkyl acrylate) according to claim 1.

9. The latex according to claim 8, the latex having a Z-average particle size of about 50 to 250 nm, as determined by a Zeta-sizer Nano ZS90 type laser nanometer particle size analyzer (Malvern, UK) with a 633 nm red laser.

10. The latex according to claim 8, the latex having a content of biobased materials of 50-95% by weight, calculated from the solid matter of the latex, provided that the poly(alkyl acrylate) is obtained from biobased raw-materials.

11. The latex according to claim 8, the latex having a solids content of 10 to 50% by weight.

12. A method of manufacturing a biobased emulsion, comprising the steps of:
providing an allylated polysaccharide ether derivative; and
grafting the allylated polysaccharide ether derivative with a poly(alkyl acrylate) by emulsion polymerization,
wherein the allylated polysaccharide ether derivative is obtained by reacting a polysaccharide with a bi-functional reactant containing epoxy groups and unsaturated groups to chemically bond to the polysaccharide by etherification.

13. The method according to claim 12, wherein the allylated polysaccharide ether derivative is obtained by reacting the polysaccharide with a bi-functional reactant comprising epoxy groups and vinyl groups to chemically bond to polysaccharide by etherification.

14. The method according to claim 13, wherein the bi-functional reactant comprising epoxy groups and vinyl groups is allyl glycidyl ether.

15. The method according to claim 12, wherein the allylated polysaccharide ether derivative exhibits ether substituents with allyl groups at a degree of substitution of up to 1.5.

16. The method according to claim 12, wherein the grafting the allylated polysaccharide ether derivative with a poly(alkyl acrylate) by emulsion polymerization is done by polymerization of an alkyl-acrylate monomer is selected from the group consisting of ethyl acrylate, n-propyl acrylate, isopropyl acrylate, n-butyl acrylate, isobutyl acrylate, n-hexyl methacrylate, n-octyl methacrylate, and isooctyl acrylate monomers and combinations thereof in the presence of the polysaccharide ether.

17. The method according to claim 12, wherein the polysaccharide has a number average molecular weight of 2,000-50,000 g/mol and a weight average molecular weight of 2,000-100,000 g/mol, as measured by a high-performance-size exclusion chromatography.

18. The method according to claim 12, wherein the polysaccharide is selected from the group consisting of starch, guar gum and hemicellulose.

19. The method according to of claim 18, wherein the hemicellulose is selected from the group consisting of galactoglucomannan, xylan, arabinogalactan, arabino-gluronoxylan, xyloglucan, beta-glucan, alpha-glucan, and combinations thereof.

20. The method according to claim 12, wherein the emulsion polymerization is carried out by semi-continuous emulsion polymerization.

21. The method according claim 12, wherein the emulsion polymerization is carried out as a one-step emulsion polymerization.

22. The method according to claim 12, wherein the etherification of the polysaccharide is carried out in an inert atmosphere at alkaline conditions.

23. The method according to claim 22, wherein the etherification comprises the steps of:
adding sodium hydroxide into a polysaccharide aqueous dispersion,
adding, after dissolving of sodium hydroxide in the polysaccharide aqueous dispersion, a bi-functional monomer at a molar ratio of 1:1 to 1:5, based on anhydromonose units,
carrying out the etherification until completion in an inert atmosphere, and
optionally neutralizing the reaction mixture using a mineral acid.

24. The method according to claim 12, wherein the method further comprises filtering the allylated polysaccharide ether derivative with a membrane to remove unreacted monomer, said filtering being carried out for a period of 1 to 180 h.

25. The method according to claim 12, further comprising carrying out the grafting reaction in the presence of a surfactant, and by further adding a radical initiator.

26. The method according to claim 12, wherein the method further comprises casting and drying the formed emulsion into a film at 23° C. and 50% humidity.

27. A biobased emulsion or binder formed by the method according to claim 12.

28. A biobased film formed by the method according to claim 12.

29-39. (canceled)

40. The polysaccharide ether according to claim 1, the polysaccharide ether having a degree of substitution of up to 1.0.
